(19) United States
(12) Patent Application Publication
(10) Pub. No.: US 2026/0327041 A1
(43) Pub. Date: Oct. 22, 2026

(54) ELEVATOR SYSTEM, RELAY APPARATUS, SECOND RELAY APPARATUS, RELAY METHOD, AND COMPUTER-READABLE RECORDING MEDIUM

(71) Applicant: Mitsubishi Electric Building Solutions Corporation, Tokyo (JP)

(72) Inventor: Takuya NAKAYAMA, Tokyo (JP)

(73) Assignee: Mitsubishi Electric Building Solutions Corporation, Tokyo (JP)

(21) Appl. No.: 19/113,947

(22) PCT Filed: Sep. 28, 2022
(86) PCT No.: PCT/JP2022/036180

§ 371 Date: Mar. 21, 2025

(51) Int. Cl. B66B 1/46; B66B 1/18; B66B 1/34

(52) U.S. Cl. CPC B66B 1/468; B66B 1/18; B66B 1/3461; B66B 2201/103; B66B 2201/4615; B66B 2201/4638; B66B 2201/4653

(57) ABSTRACT

An elevator system includes: a plurality of first-relay-apparatuses, the plurality of first-relay-apparatuses being connected so as to be capable of receiving pieces of elevator information obtained from car-operating-panels of corresponding cars, respectively, and transmitting instructions executable from the car-operating-panels to car-control-devices, respectively; and a second-relay-apparatus connected so as to be capable of communicating with each of the plurality of first-relay-apparatuses. The second-relay-apparatus receives a use request, the use request including information about a call from a boarding floor to a destination floor of a control-target-robot moving in the facility, determines an assigned car to which the call of the robot included in the use request is to be assigned, and transmits a request to register the call of the robot to a first-relay-apparatus corresponding to the assigned car. The first relay apparatus transmits the received request to register the call of the robot to a corresponding car-control-device.

### FIELD

The present disclosure relates to an elevator system, a relay apparatus, a second relay apparatus, a relay method, and a computer-readable recording medium.

### BACKGROUND

PTL 1 discloses a technology of an unmanned conveyance vehicle moving among floors by a button press-down assist unit that is removably fitted to an elevator operating panel. The unmanned conveyance vehicle of this technology includes a communication unit that performs communication with the button press-down assist unit installed later. When the unmanned conveyance vehicle transmits a signal to press a button for upper floors at an elevator hall, the button for upper floors is pressed down by the button press-down assist unit. Further, the button press-down assist unit detects that the button that has lit up goes out and sends a signal thereof to the unmanned conveyance vehicle.

### CITATION LIST

### Patent Literature

[PTL 1] JP 2022-70316 A

### SUMMARY

### Technical Problem

In the technology of PTL 1, it is necessary to realize boarding and alighting of a robot only with information obtained from the elevator operating panel and functions executable from the elevator operating panel. In order to make it possible for the robot to highly cooperate with the elevator under such restrictions, much human labor is required in modernization of the elevator, modification of software, and the like.

The present disclosure has been made to solve the problem as described above, and an object thereof is to, at the time of providing an elevator system that realizes boarding and alighting of a robot by cooperation between an elevator and the robot, reduce the burden on persons involved in modernization or modification of software.

### Solution to Problem

An elevator system of the present disclosure includes: a plurality of first relay apparatuses corresponding to a plurality of cars of an elevator provided in a facility, respectively, and being connected so as to be capable of receiving pieces of elevator information obtained from car operating panels of the corresponding cars, respectively, and transmitting instructions executable from the car operating panels to car control devices, respectively; and a second relay apparatus connected so as to be capable of communicating with each of the plurality of first relay apparatuses. The second relay apparatus includes: a second reception unit receiving a use request, the use request including information about a call from a boarding floor to a destination floor of a robot moving in the facility; and a second transmission unit transmitting, to a first relay apparatus corresponding to an assigned car to which the call of the robot included in the use request is assigned, among the plurality of first relay apparatuses, a request to register the call of the robot. Each of the plurality of first relay apparatuses includes: a first reception unit receiving the request to register the call of the robot transmitted by the second transmission unit; and a first transmission unit transmitting the request to register the call of the robot received by the first reception unit, to a corresponding car control device among the car control devices.

A second relay apparatus of the present disclosure is communicably connected to each of a plurality of first relay apparatuses, the plurality of first relay apparatuses corresponding to a plurality of cars of an elevator provided in a facility, respectively, and being connected so as to be capable of receiving pieces of elevator information obtained from car operating panels of the corresponding cars, respectively, and transmitting instructions executable from the car operation panels to car control devices, respectively. The second relay apparatus includes: a second reception unit receiving a use request, the use request including information about a call from a boarding floor to a destination floor of a robot moving in the facility; and a second transmission unit transmitting, to a first relay apparatus corresponding to an assigned car to which the call of the robot included in the use request is assigned, among the plurality of first relay apparatuses, a request to register the call of the robot to be transmitted to a corresponding car control device among the car control devices.

A relay apparatus of the present disclosure is connected so as to be capable of receiving pieces of elevator information obtained from car operating panels of a plurality of cars of an elevator provided in a facility, respectively, and transmitting instructions executable from the car operating panels to car control devices corresponding to the plurality of cars, respectively. The relay apparatus includes: a reception unit receiving a use request, the use request including information about a call from a boarding floor to a destination floor of a robot moving in the facility; and a transmission unit transmitting, to a car control device corresponding to an assigned car to which the call of the robot included in the use request is assigned, among the car control devices corresponding to the plurality of cars, respectively, a request to register the call of the robot.

A relay method of the present disclosure receives pieces of elevator information obtained from car operating panels of a plurality of cars of an elevator provided in a facility, respectively, and transmits instructions executable from the car operating panels to car control devices corresponding to the plurality of cars, respectively. The method includes the steps of: receiving a use request, the use request including information about a call from a boarding floor to a destination floor of a robot moving in the facility; determining an assigned car to which the call of the robot included in the use request is to be assigned, based on the pieces of elevator information; and transmitting a request to register the call of the robot to a car control device corresponding to the assigned car.

In a computer-readable recording medium of the present disclosure, a relay program is recorded, the relay program causing a computer to execute: receiving pieces of elevator information obtained from car operating panels of a plurality of cars of an elevator provided in a facility, respectively, and transmitting instructions executable from the car operating panels to car control devices corresponding to the plurality of cars, respectively. The relay program is configured to cause the computer to execute: receiving a use request, the use request including information about a call from a boarding floor to a destination floor of a robot moving in the facility; determining an assigned car to which the call of the robot included in the use request is to be assigned, based on the pieces of elevator information; and transmitting a request to register the call of the robot to a car control device corresponding to the assigned car.

### Advantageous Effects of Invention

According to the present disclosure, it becomes possible to, at the time of providing an elevator system that realizes boarding and alighting of a robot by cooperation between an elevator and the robot, reduce the burden on persons involved in modernization or modification of software.

### BRIEF DESCRIPTION OF THE DRAWINGS

FIG. 1 is a configuration diagram of a building system according to a first embodiment;

FIG. 2 is a block diagram showing functions of an elevator system according to the first embodiment;

FIG. 3 is a flowchart showing an operation example of the elevator system according to the first embodiment;

FIG. 4 shows an example of selection of an assigned car by a second relay apparatus according to the first embodiment;

FIG. 5 is a hardware configuration diagram of a main part of the elevator system

FIG. 6 is a block diagram showing functions of an elevator system according to a second embodiment;

FIG. 7 is a flowchart showing an operation example of the elevator system according to the second embodiment;

FIG. 8 is a block diagram showing functions of an elevator system according to a third embodiment;

FIG. 9 shows an example of selection of an evacuation floor by an evaluation floor selection unit;

FIG. 10 is a flowchart showing an operation example of the elevator system according to the third embodiment;

FIG. 11 is a block diagram showing functions of an elevator system according to a fourth embodiment;

FIG. 12 is a flowchart showing an operation example of the elevator system according to the fourth embodiment;

FIG. 13 is a configuration diagram of a building system according to a fifth embodiment; and

FIG. 14 is a block diagram showing functions of an elevator system according to the fifth embodiment.

### DESCRIPTION OF EMBODIMENTS

Embodiments will be described below with reference to drawings. In the drawings, common components will be given the same reference signs, and duplicate description thereof will be omitted.

### First Embodiment

### 1-1. Configuration of Building System of First Embodiment

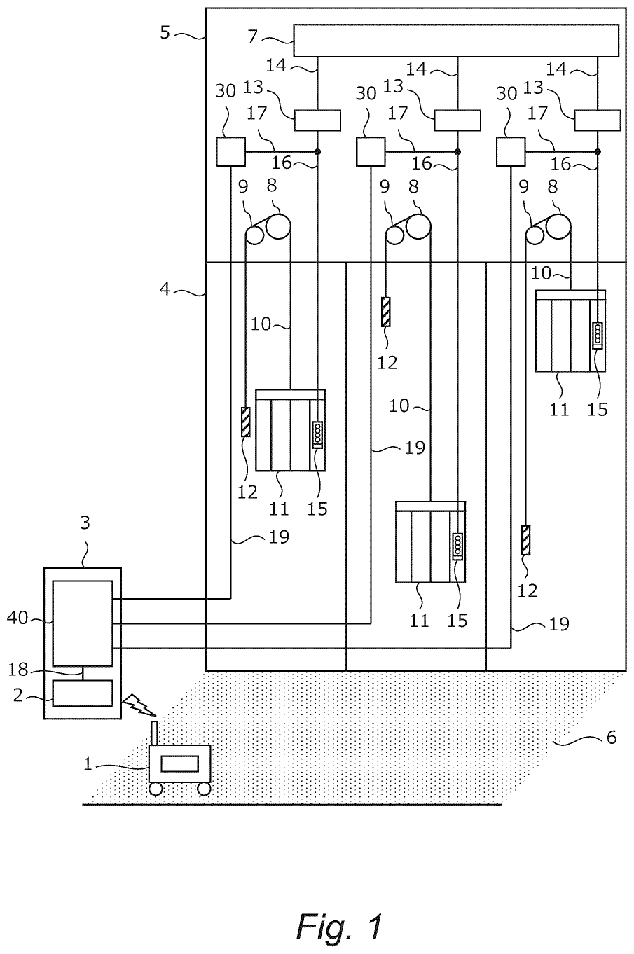

FIG. 1 is a configuration diagram of a building system according to a first embodiment.

The building system is applied to a facility. The facility is, for example, an indoor facility or an outdoor facility, or a combination of indoor and outdoor facilities.

The facility includes one or more buildings and the like. The facility may be, for example a part of a building or the like. The building system applied to the facility includes a robot 1 that moves in the facility. In this example, the robot 1 operates based on control by a robot server 2. The robot 1 wirelessly communicates with the robot server 2. In the facility, a control room 3 is provided. The control room 3 is a place where a facility administrator or the like performs management of the facility and the like. The robot server 2 is provided, for example, in the control room 3. The building system includes an elevator system as an internal system.

The elevator system includes an elevator. In the facility, an elevator hoistway 4 for the elevator is provided. The hoistway 4 is space through a plurality of floors, with the vertical direction as a longitudinal direction. At an upper part of the hoistway 4, an elevator machine room 5 is provided. In the facility, halls 6 are provided for the floors. The halls 6 are places that lead to the hoistway 4.

The elevator includes a plurality of units and a group control apparatus 7. Each of the units includes a traction machine 8, a deflector wheel 9, a main rope 10, a car 11, a counterweight 12, and a car control device 13. The group control apparatus 7, and the traction machine 8, the deflector wheel 9, and the car control device 13 of each of the units are provided in the machine room 5. The car 11 and the counterweight 12 are provided in the hoistway 4. The traction machine 8 includes a motor that generates driving force and a sheave that rotates by the driving force generated by the motor. The main rope 10 is wound around the sheave of the traction machine 8 and the deflector wheel 9. The main rope 10 supports the load of the car 11 on one side of the sheave of the traction machine 8. The main rope 10 supports the load of the counterweight 12 on the other side of the sheave of the traction machine 8. The car 11 and the counterweight 12 travel toward mutually opposite sides in the vertical direction of the hoistway via the sheave of the traction machine 8 and the main rope 10, by the driving force generated by the motor of the traction machine 8. By traveling through the hoistway 4, the car 11 transports users, the robot, and the like that are inside the car 11 among the plurality of floors of the facility.

The car control device 13 of each of the units corresponds to the car 11 of the same unit. The car control device 13 electrically connects to the traction machine 8 of the same unit. The car control device 13 is connected to a corresponding car 11 through a corresponding car transmission cable 16. The car control device 13 controls travel of the car 11 through control of the traction machine 8. The car control device 13 of each of the units electrically connects to the group control apparatus 7 via a transmission cable 14. The group control apparatus 7 accepts information about a hall call by a user accepted by a hall operating panel not shown, which is provided at each of the elevator hall 6. The group control apparatus 7 assigns the hall call to any of the cars 11.

Each car 11 includes a car operating panel 15. The car operating panel 15 is an elevator operating panel that accepts a car call operation by an elevator user.

Information about a car call accepted by the car operating panel 15 of each car 11 is transmitted to a car control device 13 corresponding to the car 11 through a corresponding car transmission cable 16.

The elevator system includes a plurality of first relay apparatuses 30 and a second relay apparatus 40. The first relay apparatuses 30 are, for example, protocol converters. Each of the first relay apparatuses 30 corresponds to any of the units. Each of the first relay apparatus 30 electrically connects to the car control device 13 of a corresponding unit via a corresponding relay cable 17. The relay cable 17 connecting to the first relay apparatus 30 is electrically connected to a corresponding car transmission cable 16, which connects the car control device 13 and the car 11, in the unit to which the first relay apparatus 30 corresponds. Each of the first relay apparatuses 30 is provided in the machine room 5.

The second relay apparatus 40 is an apparatus separate from the group control apparatus 7. The second relay apparatus 40 is provided in the control room 3. The second relay apparatus 40 electrically connects to the robot server 2 via a cable 18. The second relay apparatus 40 may wirelessly connect to the robot server 2. The second relay apparatus 40 electrically connects to the first relay apparatuses 30 via hoistway transmission cables 19, respectively. For each of the units, the second relay apparatus 40 connects to the car control device 13 via the first relay apparatus 30. That is, each of the first relay apparatuses 30 intervenes between a corresponding car control device 13 and the second relay apparatus 40.

The second relay apparatus 40 executes each function by reading out a relay program recorded in a computer-readable recording medium and operating according to the relay program. The recording medium in which the relay program is recorded may be, for example, included in the second relay apparatus 40 or connected to the second relay apparatus 40. The relay program may be, for example, installed into the second relay apparatus 40 via a communication network, for example, the Internet or may be installed in the second relay apparatus 40 by being read out from an external portable recording medium in which the relay program is recorded.

In the building system, the robot 1 uses among the plurality floors of the facility using the elevator. When the robot 1 uses an elevator, a use request including call information is transmitted. The use request is transmitted, for example, from the robot server 2 that controls the robot 1. Or alternatively, the use request may be transmitted from the robot 1. The information about the call of the robot 1 includes information about boarding and destination floors of the robot 1. The use request is transmitted to the second relay apparatus 40. The second relay apparatus 40 performs processing for assigning the call of the robot 1 to any of the cars 11.

Assignment of the call of the robot 1 is performed, for example, based on pieces of elevator information. The pieces of elevator information are transmitted, for example, from the first relay apparatuses 30, respectively, to the second relay apparatus 40. In this example, the group control apparatus 7 does not perform the processing for assigning the call of the robot 1 to any of the cars 11. The second relay apparatus 40 transmits a registration request including the call information to a first relay apparatus 30 corresponding to a car 11 to which the call of the robot 1 is assigned. The second relay apparatus 40 transmits information identifying the car 11 to which the call of the robot 1 is assigned, to the robot server 2 that controls the robot 1.

The first relay apparatus 30 that has received the call registration request from the second relay apparatus 40 pretends to be the car operating panel 15 of the corresponding car 11 to transmit an instruction executable from the car operating panel 15, to a car control device 13. Here, the second relay apparatus 40 transmits, as a car call of the car 11, information about the call to a car control device 13 that controls the car 11.

### 1-2. Functions of Elevator System of First Embodiment

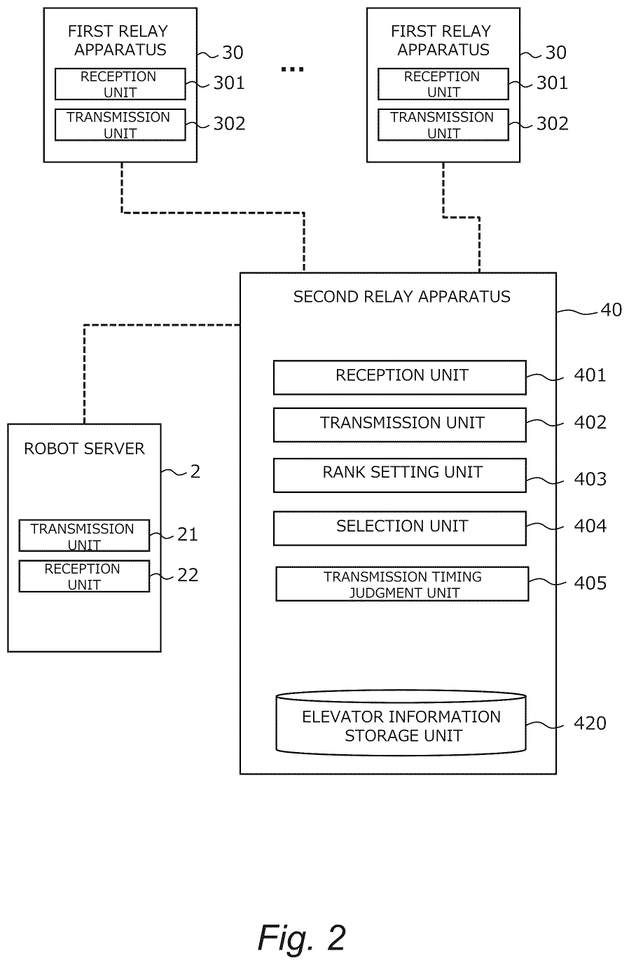

FIG. 2 is a block diagram showing functions of the elevator system according to the first embodiment.

The robot server 2 includes a transmission unit 21 and a reception unit 22. The second relay apparatus 40 includes a reception unit 401 as a second reception unit, a transmission unit 402 as a second transmission unit, a rank setting unit 403, a selection unit 404, a transmission timing judgment unit 405, and an elevator information storage unit 420. Each of the first relay apparatuses 30 includes a reception unit 301 as a first reception unit and a transmission unit 302 as a first transmission unit.

The transmission unit 21 of the robot server 2 has a function of transmitting a use request including information about a call of the robot 1, to the reception unit 401 of the second relay apparatus 40 and a function of transmitting a robot operation stop signal and a robot operation resumption signal to the reception unit 401 of the second relay apparatus 40. The robot operation here is an elevator operation in response to a call of the robot 1. Further, the robot operation stop signal is a signal that requests to stop the robot operation due to a factor on the robot side by a failure of the robot 1. Further, the robot operation resumption signal is a signal that requests resumption of the robot operation while the robot operation is stopped. The reception unit 22 of the robot server 2 has a function of receiving assigned car information identifying a car 11 to which a call of the robot 1 is assigned, from the transmission unit 402 of the second relay apparatus 40.

The reception unit 401 of the second relay apparatus 40 has a function of receiving a use request and a robot operation stop signal from the transmission unit 21 of the robot server 2 and a function of receiving pieces of elevator information from the transmission units 302 of the first relay apparatuses 30.

The elevator information storage unit 420 has a function of storing pieces of elevator information. The pieces of elevator information include pieces of information obtained from the car operating panels 15 of the units, respectively. The piece of elevator information about each of the units includes car position information, car travel direction information, door open button lamp lighting information, in-car destination floor button lighting information, and in-car destination floor button registration possibility/impossibility information about the car 11.

The rank setting unit 403 has a function of setting ranks as candidate cars to which a call of the robot 1 is to be assigned, for a part or all of the plurality of cars 11. The rank setting unit 403 sets ranks of the cars 11 based on pieces of elevator information stored in the elevator information storage unit 420.

The selection unit 404 has a function of selecting an assigned car to which a call of the robot 1 is to be assigned from among candidate cars for which ranks have been set by the rank setting unit 403. The selection unit 404 selects an assigned car based on raking set by the rank setting unit 403. The selection unit 404 selects, for example, a candidate car the set rank of which is first place, as the assigned car.

The transmission timing judgment unit 405 has a function of judging a timing of transmitting a boarding-floor car call to an assigned car selected by the selection unit 404, based on pieces of elevator information stored in the elevator information storage unit 420. The transmission timing judgment unit 405 judges, for example, a timing when a boarding floor and a destination floor are located in that order ahead in the travel direction of a car 11, as the timing of transmitting a boarding-floor car call.

The transmission unit 402 of the second relay apparatus 40 has a function of transmitting a request to register a boarding-floor car call to an assigned car selected by the selection unit 404 and a request to register a destination-floor car call to the assigned car, to the reception unit 301 of a corresponding first relay apparatus 30. Further, the transmission unit 402 of the second relay apparatus 40 has a function of transmitting information identifying the assigned car selected by the selection unit 404, to the reception unit 22 of the robot server 2.

The reception unit 301 of each of the first relay apparatuses 30 has a function of receiving a call registration request and the like from the transmission unit 402 of the second relay apparatus 40. The reception unit 301 of each of the first relay apparatuses 30 has a function of, each time elevator information about a corresponding unit changes, receiving the elevator information from the car control device 13 of the unit.

The transmission unit 302 of each of the first relay apparatuses 30 has a function of transmitting a call registration request transmitted by the transmission unit 402 of the second relay apparatus 40 as a car call to the car 11 of a corresponding unit, to the car control device 13 that controls the car 11. The transmission unit 302 of each of the first relay apparatuses 30 has a function of, each time elevator information about a corresponding unit changes, transmitting the elevator information to the reception unit 401 of the second relay apparatus 40.

### 1-3. Operation Example of Elevator System

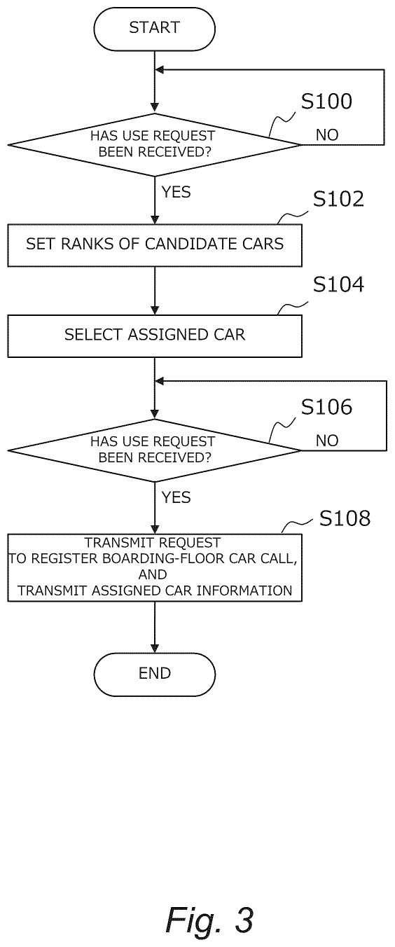

FIG. 3 is a flowchart showing an operation example of the elevator system according to the first embodiment. Here, a description will be made on a series of operations until the elevator system registers a boarding-floor car call of the robot 1.
Further, the flowchart also indicates a part of a relay method according to the embodiments of the present disclosure.

At step S100, the second relay apparatus 40 judges whether the reception unit 401 has received a use request including information about a call of the robot 1, from the transmission unit 21 of the robot server 2. As a result, if the judgment is recognized to be positive, the process proceeds to step S102; and, if the judgment is not recognized to be positive, the process returns to the processing of step S100 again.

At step S102, the rank setting unit 403 sets ranks as candidate cars for a plurality of cars 11, based on information stored in the elevator information storage unit 420.

When the processing of step S102 is performed, the process proceeds to step S104.

At step S104, the selection unit 404 selects a candidate car the rank of which has been set to first place by the rank setting unit 403, as an assigned car. When the processing of step S104 is performed, the process proceeds to step S106.

At step S106, the transmission timing judgment unit 405 judges whether or not a condition is met that a boarding floor and a destination floor are located in that order ahead in the travel direction of the assigned car, based on the elevator information. As a result, if the condition is not recognized to be met, the process returns to step S106 again; and, if the condition is recognized to be met, the process proceeds to step S108.

At step S108, the transmission unit 402 transmits a request to register a boarding-floor car call to the assigned car selected by the selection unit 404, to the reception unit 301 of a first relay apparatus 30 corresponding to the assigned car. Further, the transmission unit 402 transmits assigned car information identifying the assigned car selected by the selection unit 404, to the reception unit 22 of the robot server 2. After that, the process of the second relay apparatus 40 ends.

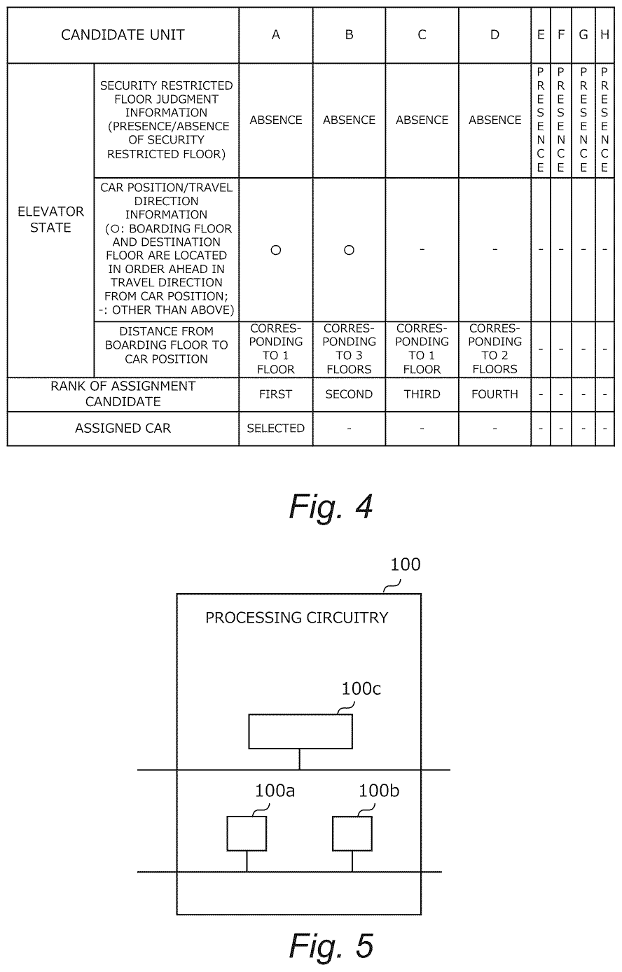

Next, an example of selection of an assigned car by the second relay apparatus 40 according to the first embodiment will be described using FIG. 4. FIG. 4 shows the example of selection of an assigned car by the second relay apparatus 40 according to the first embodiment.

In this example, the elevator includes eight units of Units A to H. A use request of the robot 1 transmitted to the second relay apparatus 40 via the robot server 2 and the like is transmitted when the robot 1 moves from a boarding floor to a destination floor.

The rank setting unit 403 obtains an elevator state for each of the units based on elevator information. The elevator state for each of the units includes security restricted floor judgment information, car position/travel direction information, and information about a distance from the boarding floor of the robot 1 to the car 11. The security restricted floor judgment information is information identifying security restricted floors where boarding and alighting are restricted from a security point of view. The car position/travel direction information is information showing whether or not the boarding floor and the alighting floor are located in that order ahead in the travel direction of the car 11. At the time of setting ranks of assignment candidates, priority is set for use of the above pieces of information. In this example, the order of the security restricted floor judgment information, the car position/travel direction information, and the information about the distance from the boarding floor of the robot 1 to the car 11 is descending priority order.

First, the rank setting unit 403 performs judgment processing based on the security restricted floor judgment information with the highest priority. The rank setting unit 403 judges whether the boarding floor or the destination floor is a security restricted floor or not, based on in-car destination floor button registration possibility/impossibility information stored in the elevator information storage unit 420. Depending on an elevator system, however, there may be a case where it is set in specifications that call registration is invalidated for back floors, which are floors located on an opposite side of the travel direction of a car. In such an elevator system, the back floors are included among floors that cannot be registered in the in-car destination floor button registration possibility/impossibility information, and there is a possibility that it is not possible to accurately identify security restricted floors.

Here, since no floor is a back floor during non-directional stop of a car 11, it is possible to judge security restricted floors separately from back floors. Therefore, the rank setting unit 403 reads out in-car destination floor button registration possibility/impossibility information obtained during the latest non-directional stop of each car 11. Then, the rank setting unit 403 judges whether or not the boarding or destination floor of the robot 1 is included among security restricted floors that cannot be registered, in each piece of in-car destination floor button registration possibility/impossibility information that has been read out. Then, the rank setting unit 403 excludes cars 11 of such Units that the boarding floor or the destination floor is included among the security restricted floors, from candidate cars. In the example shown in FIG. 4, the rank setting unit 403 provisionally sets Units A to D, for which the boarding floor and the destination floor are service floors, as being tied for first place and excludes Units E to H, for which the boarding floor and the destination floor are security restricted floors, from the candidate cars. For example, as for the cars 11 excluded from the candidate cars, the rank setting unit 403 may omit the subsequent ranks setting processing.

Then, the rank setting unit 403 performs judgment processing based on the car position/travel direction information with the next highest priority. The rank setting unit 403 judges whether or not the boarding and destination floors of the robot 1 are located in that order ahead in the travel direction of the car 11. In the example shown in FIG. 4, the rank setting unit 403 provisionally sets Units A and B, for which the boarding floor and the destination floors are located in that order ahead in the travel direction of the car 11, as being tied for first place, and provisionally sets Units C and D, for which the boarding floor and the destination floors are not located in that order ahead in the travel direction of the car 11, as being tied for third place.

Then, the rank setting unit 403 performs judgment processing based on the distance from the boarding floor with the next highest priority. The rank setting unit 403 sets a car 11 with a shorter distance from the boarding floor higher. For Units A and B that are provisionally tied for the first place, for example, the rank setting unit 403 sets Unit A the distance of which from the boarding floor corresponds to one floor as being in first place, and sets Unit B the distance of which from the boarding floor corresponds to three floors as being in second place. Further, for Units C and D that are provisionally tied for third place, the rank setting unit 403 sets, for example, Unit C the distance of which from the boarding floor corresponds to one floor as being in third place, and sets Unit D the distance of which from the boarding floor corresponds to two floors as being in fourth place.

When there are candidates at the same rank when ranks based on the elevator states have been set, the rank setting unit 403 sets a car 11 with a smaller unit number higher so that there are no candidate cars with the same rank.

The selection unit 404 selects Unit A the rank of which has been set to first place by the rank setting unit 403, as the assigned car.

### 1-4. Operation and Effects of Elevator System of First Embodiment

Next, operation and effects of the elevator system according to the first embodiment will be described.

The second relay apparatus 40 receives a use request from the robot server 2 and selects an assigned car to which a call included in the use request is to be assigned. The second relay apparatus 40 transmits a request to register the call, to a first relay apparatus 30 connected to a car control device 13 that controls the assigned car, via a corresponding hoistway transmission cables 19. The first relay apparatus 30 pretends to be the car operating panel 15 of the assigned car to transmit the registration request to the car control device 13 as a car call. Thus, since the group control apparatus 7 does not require a function of communicating with the second relay apparatus 40 and the like, cooperation between the elevator and the robot 1 becomes possible even for the group control apparatus 7 that is not equipped with a communication function. Since, at the time of causing the elevator of an old model and the robot 1 to cooperate, modernization of the elevator and modification of the software of the group control apparatus 7 are not required, it is possible to reduce the cost and management work burdens on an administrator and the like who perform management of the elevator.

Further, the second relay apparatus 40 can judge security restricted floors separately from back floors, based on in-car destination floor button registration possibility/impossibility information obtained during the latest non-directional stop of each car 11. Thereby, it is possible to reduce the possibility of misjudging back floors as security restricted floors and include the back floors among candidate cars. Thereby, the number of candidate car targets increases, and it is possible to select an appropriate assigned car for enhancing operation efficiency.

Further, the second relay apparatus 40 can set Unit, for which a boarding floor and a destination floor are located in that order ahead in the travel direction of the car 11, at a higher rank than Units, for which the boarding and the destination floor are not located so, based on pieces of elevator information. Thereby, it is possible to set a car 11 that is more smoothly movable from a boarding floor to a destination floor at a higher rank, and the operation efficiency is enhanced.

Further, the rank setting unit 403 sets ranks as assignment candidates, based on information stored in the elevator information storage unit 420. The selection unit 404 selects a candidate car set as being in first place by the rank setting unit 403, as an assigned car. Thereby, an advantage is obtained that it becomes possible for the second relay apparatus 40 to assign a car 11 which the robot 1 can board and which arrives at a boarding floor early. Further, since the second relay apparatus 40 selects an assigned car, a further advantage is obtained that the processing load on the group control apparatus 7 can be reduced.

When the condition is met that the boarding and destination floors of the robot 1 are located in that order in the travel direction of an assigned car, the second relay apparatus 40 judges that it is the timing to transmit a car call to the boarding floor of the robot 1. If, when the boarding and destination floors of the robot 1 are located at back floors, a car call is sent to the floors, there is a possibility of occurrence of a phenomenon that the car call disappears when the direction of the car 11 is reversed. The judgment of the above condition has an advantage that it is possible to avoid such a phenomenon. Furthermore, an advantage is also obtained that, after the robot 1 boards, the car 11 can smoothly move to the destination floor without the travel direction of the car 11 being reversed.

### 1-5. Modification

The elevator system of the first embodiment may adopt the following modified aspects. The modifications are applicable to elevator systems of other embodiments to be described later.

The robot 1 may perform communication with the second relay apparatus 40 not via the robot server 2.

Further, a part or all of the functions of the robot server 2 and the second relay apparatus 40 may be mounted on an apparatus provided outside the facility. A part or all of the functions of the robot server 2 and the second relay apparatus 40 may be implemented over a plurality of pieces of hardware. At this time, the pieces of hardware are mutually communicably connected via a communication network such as the Internet. Further, a part or all of the functions of the robot server 2 and the second relay apparatus 40 may be implemented by processing and storage resources on a cloud service.

FIG. 5 is a hardware configuration diagram of a main part of the elevator system according to the first embodiment. Each function of the elevator system can be realized by processing circuitry 100. The processing circuitry 100 includes at least one processor 100a and at least one memory 100b. The processing circuitry may include at least one piece of dedicated hardware 100c together with or instead of the processor 100a and the memory 100b.

When the processing circuitry includes the processor 100a and the memory 100b, each function of the building system is realized by software, firmware, or a combination of software and firmware. At least any of the software and the firmware is written as a program. The program is stored in the memory 100b. The processor 100a realizes each function of the elevator system by reading out and executing the program stored in the memory 100b.

The processor 100a is also referred to as a CPU (central processing unit), a processing device, an arithmetic device, a microprocessor, a microcomputer, or a DSP. The memory 100b includes a nonvolatile or volatile semiconductor memory, for example, a RAM, a ROM, a flash memory, an EPROM, and an EEPROM.

When the processing circuitry includes the dedicated hardware 100c, the processing circuitry is realized, for example, with a single circuit, a composite circuit, a programmed processor, a parallel-programmed processor, an ASIC, an FPGA, or a combination thereof.

Each function of the elevator system can be realized by the processing circuitry. Or alternatively, the functions of the elevator system can be collectively realized by the processing circuitry. For each function of the elevator system, it is possible to realize a part thereof by the dedicated hardware 100c and realize the other part by software or firmware. Thus, the processing circuitry realizes each function of the building system by the dedicated hardware 100c, software, firmware, or a combination thereof.

### Second Embodiment

In a second embodiment, points different from the example disclosed in the first embodiment will be especially described in detail. As for characteristics that are not described in the second embodiment, any of the characteristics disclosed in the first embodiment may be adopted.

### 2-1. Functions of Elevator System of Second Embodiment

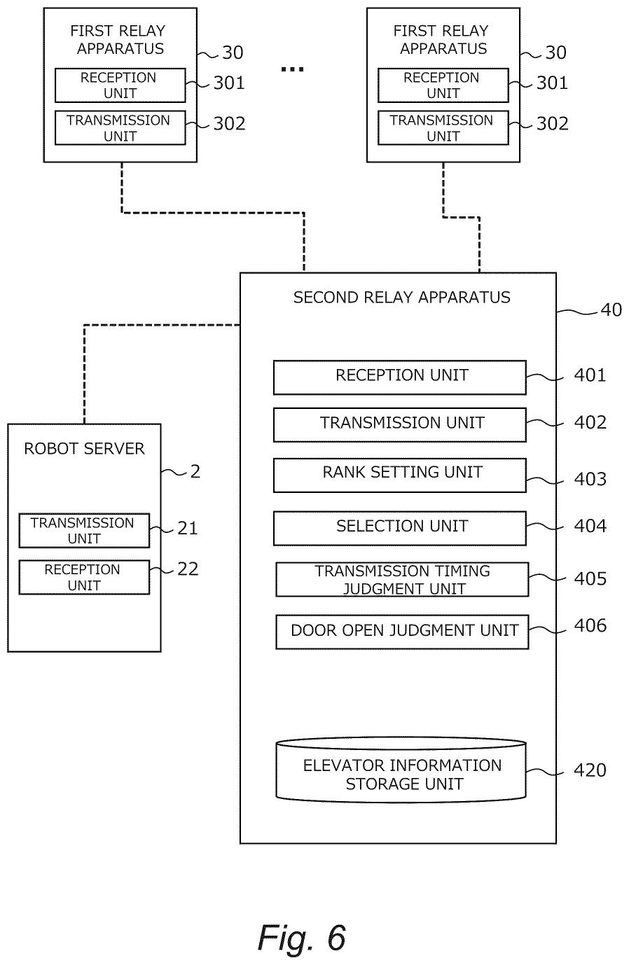

FIG. 6 is a block diagram showing functions of the elevator system according to the second embodiment. The second relay apparatus 40 of the second embodiment further includes a door open judgment unit 406 in addition to the functions of the second relay apparatus 40 of the first embodiment.

The door open judgment unit 406 has a function of judging whether or not an assigned car selected by the selection unit 404 has arrived at a boarding floor and opened the door, based on elevator information stored in the elevator information storage unit 420.

### 2-2. Operation Example Of Elevator System of Second Embodiment

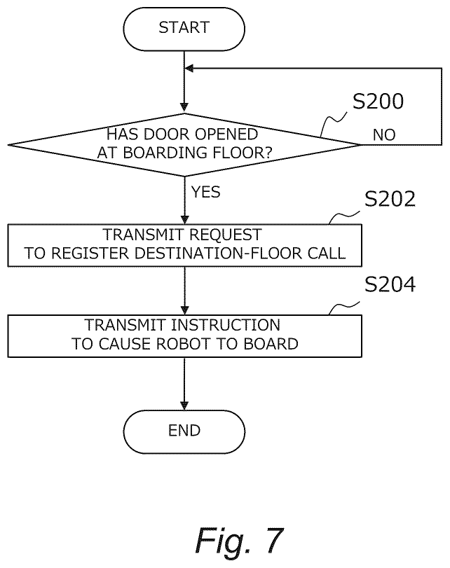

FIG. 7 is a flowchart showing an operation example of the elevator system according to the second embodiment. Here, a description will be made on a series of operations until, after registering a boarding-floor car call of the robot 1 by executing the process of the flowchart shown in FIG. 5, the elevator system transmits a boarding instruction to the robot 1.

At step S200, the door open judgment unit 406 judges whether a door open condition is met or not that the door of the assigned car is open at the boarding floor of the robot 1, based on the elevator information stored in the elevator information storage unit 420. Here, the door open judgment unit 406 judges whether the current car position of the assigned car is at the boarding floor or not based on car position information and judges, based on door open button lamp lighting information about the assigned car, whether the door open button lamp is in a lighting state or not. As a result, if any one of the above judgments is not recognized to be met, the process returns to step S200 again; and, if both of the above judgments are recognized to be met, the process proceeds to the next step S202.

At step S202, the transmission unit 402 transmits a request to register a destination-floor car call to the assigned car selected by the selection unit 404, to the reception unit 301 of a first relay apparatus 30 corresponding to the assigned car. When the processing of step S202 is executed, the process proceeds to step S204.

At step S204, the transmission unit 402 transmits an instruction to cause the robot 1 to board the assigned car selected by the selection unit 404, to the reception unit 22 of the robot server 2.

### 2-3. Operation and Effects of Elevator System of Second Embodiment

Next, operation and effects of the elevator system according to the second embodiment will be described.

The door open judgment unit 406 of the second relay apparatus 40 is adapted to, when judging that the door of an assigned car is open at the boarding floor of the robot 1, proceed to the destination-floor car call registration transmission processing. Thereby, it is possible to register a destination floor immediately before the robot 1 boards, and an advantage is obtained that it is possible to reduce a risk of a wasteful destination-floor call.

### Third Embodiment

In a third embodiment, points different from the examples disclosed in the first or second embodiment will be especially described in detail. As for characteristics that are not described in the third embodiment, any of the characteristics of the examples disclosed in the first or second embodiment may be adopted.

### 3-1. Functions of Elevator System of Third Embodiment

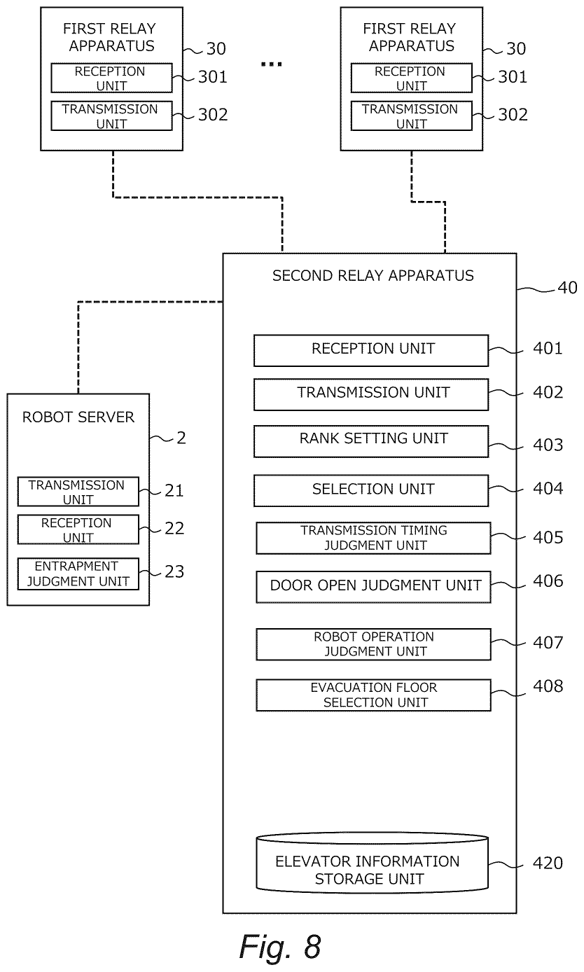

FIG. 8 is a block diagram showing functions of the elevator system according to the third embodiment. The robot server 2 of the third embodiment further includes an entrapment judgment unit 23 in addition to the functions of the first and second embodiments. Further, the second relay apparatus 40 of the third embodiment further includes a robot operation judgment unit 407 and an evacuation floor selection unit 408 in addition to the functions of the second relay apparatuses 40 of the first and second embodiments.

The entrapment judgment unit 23 has a function of judging that the robot 1 is trapped in a car 11 and notifying a building manager or the like thereof. The configuration of the entrapment judgment unit 23 is not limited. For example, the reception unit 22 receives elevator information transmitted from the transmission unit 402 of the second relay apparatus 40. Then, the entrapment judgment unit 23 judges whether the robot 1 is trapped in a car 11 or not, based on the received elevator information.

The robot operation judgment unit 407 has a function of judging stop and resumption of robot operation of transporting the robot 1 to a destination floor, based on elevator information stored in the elevator information storage unit 420. Specifically, the robot operation judgment unit 407 reads out in-car destination floor button registration possibility/impossibility information obtained during the latest non-directional stop of the car 11. Then, the robot operation judgment unit 407 judges whether a condition is met or not that the destination floor of the robot 1 is included among security restricted floors that cannot be registered in the in-car destination floor button registration possibility/impossibility information. Then, if the condition is met, the robot operation judgment unit 407 judges that the robot operation is to be stopped.

Further, if the above condition transitions to not being met during predetermined waiting time after the robot operation being judged to be stopped, the robot operation judgment unit 407 judges that the robot operation is to be resumed. Here, the temporal restriction for the waiting time is provided to reduce the possibility that, when a state of the robot 1 being trapped in a car 11 because of stop of the robot operation due to a factor on the elevator side occurs, the robot 1 continues waiting. It is assumed that the waiting The evacuation floor selection unit 408 has a function of selecting an evacuation floor where the robot 1 is evacuated, based on elevator information stored in the elevator information storage unit 420. When the robot operation transitions from stop to resumption, it is required to immediately evacuate the robot in the car 11 outside. When the robot operation transitions from stop to resumption, the evacuation floor selection unit 408 selects an evacuation floor to evacuate the robot in the car 11.

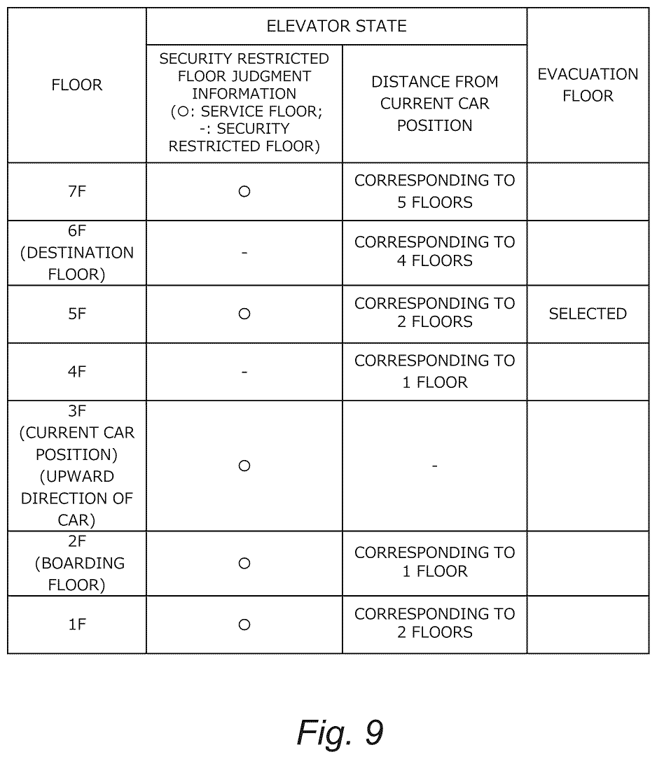

FIG. 9 shows an example of selection of an evacuation floor by the evacuation floor selection unit 408. In this example, the facility has floors 1F to 7F; the boarding floor of the robot 1 is 2F; and the destination floor is 6F. A car 11 in which the robot 1 is boarding is traveling from 2F toward 6F, and the current car position is on 3F.

As shown in FIG. 9, the evacuation floor selection unit 408 obtains an elevator state of a unit corresponding to the assigned car in which the robot 1 is boarding, based on elevator information stored in the elevator information storage unit 420. The elevator state here includes security restricted floor information and information about a distance from the current car position.

In selecting an evacuation floor, priority is set for use of the above pieces of information. In this example, the order of the security restricted floor judgment information and the information about the distance from the current car position is descending priority order.

First, the evacuation floor selection unit 408 performs judgment processing based on the security restricted floor judgment information with the highest priority. The evacuation floor selection unit 408 judges whether each floor is a security restricted floor or not, based on in-car destination floor button registration possibility/impossibility information stored in the elevator information storage unit 420. Here, similarly to the setting operation by the rank setting unit 403, the evacuation floor selection unit 408 reads out in-car destination floor button registration possibility/impossibility information obtained during the latest non-directional stop of the car 11. Then, the evacuation floor selection unit 408 judges whether or not each floor is included among security restricted floors that cannot be registered in the in-car destination floor button registration possibility/impossibility information that has been read out. Then, the evacuation floor selection unit 408 excludes the security restricted floors from evacuation floor candidates. In the example shown in FIG. 9, the evacuation floor selection unit 408 excludes 4F and 6F, which are security restricted floors, from evacuation floor candidates, and provisionally sets 1F to 3F, 5F, and 7F, which are service floors, as evacuation floor candidates.

If evacuation floor candidates are not uniquely determined by the judgment processing based on the security restricted floor judgment information, the evacuation floor selection unit 408 performs judgment processing based on the distance from the current car position with the next highest priority. The evacuation floor selection unit 408 selects a floor at the shortest distance from the current car position in the current travel direction of the car, among a plurality of excavation floor candidates, as an

### 3-2. Operation Example of Elevator System of Third Embodiment

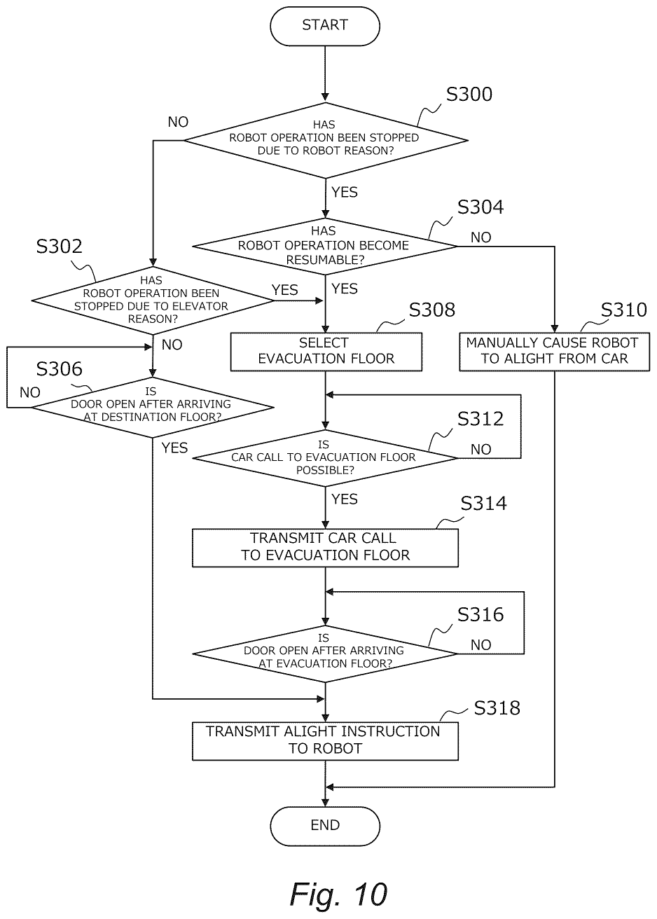

FIG. 10 is a flowchart showing an operation example of the elevator system according to the third embodiment. Here, a description will be made on a series of operations until, after transmitting a boarding instruction to the robot 1 by executing the process of the flowchart shown in FIG. 7, the elevator system transmits an alighting instruction to the robot 1.

At step S300, the second relay apparatus 40 judges whether or not a request to stop robot operation has been issued due to a factor on the robot side. Here, the second relay apparatus 40 judges whether the reception unit 401 has received a robot operation stop signal transmitted by the robot server 2 or not. As a result, if the judgment is not recognized to be positive, the process proceeds to step S302; and, if the judgment is recognized to be positive, the process proceeds to step S304.

At step S302, the robot operation judgment unit 407 of the second relay apparatus 40 judges whether or not it has been judged to stop the robot operation due to a factor on the elevator side. As a result, if the judgment is not recognized to be positive, the process proceeds to step S306; and, if the judgment is recognized to be positive, the process proceeds to step S308.

At step S304, the second relay apparatus 40 judges whether the robot operation has become resumable or not. Here, the second relay apparatus 40 judges whether or not, during predetermined waiting time after receiving the robot operation stop signal, the reception unit 401 has received a robot operation resumption signal. As a result, if the judgment is not recognized to be positive, the process proceeds to step S310; and, if the judgment is recognized to be positive, the process proceeds to step S308.

At step S306, the door open judgment unit 406 of the second relay apparatus 40 judges whether the door of the car 11 is open at the destination floor or not, based on elevator information. Here, the door open judgment unit 406 judges whether a condition is met or not that the current car position is on the destination floor in car position information, and door open button lamp lighting information indicates the lighting state. As a result, if the judgment is not recognized to be positive, the process returns to step S306 again; and, if the judgment is recognized to be positive, the process proceeds to step S318.

At step S308, the evacuation floor selection unit 408 of the second relay apparatus 40 selects an evacuation floor. When the processing of step S308 is completed, the process proceeds to step S312.

At step S310, the robot 1 is manually caused to alight from the car 11. Here, the entrapment judgment unit 23 judges that the robot 1 is trapped in the car 11 and notifies a building manager or the like thereof.

At step S312, the evacuation floor selection unit 408 of the second relay apparatus 40 judges whether a car call to the evacuation floor is possible or not. Here, the evacuation floor selection unit 408 judges whether a condition is met or not that the evacuation floor is located ahead in the travel direction of the car from the current car position. As a result, if the judgment is not recognized to be positive, the process returns to step S312 again; and, if the judgment is recognized to be positive, the process proceeds to step S314.

At step S314, the transmission unit 402 of the second relay apparatus 40 transmits a request to register a car call to the evacuation floor selected by the evacuation floor selection unit 408, to the reception unit 301 of the first relay apparatuses 30. When the processing of step S314 is completed, the process proceeds to step S316.

At step S316, the door open judgment unit 406 of the second relay apparatus 40 judges whether the door of the car 11 is open at the evacuation floor or not based on elevator information. Here, the door open judgment unit 406 judges whether a condition is met or not that the current car position is on the evacuation floor in car position information, and door open button lamp lighting information indicates the lighting state. As a result, if the judgment is not recognized to be positive, the process returns to step S316 again; and, if the judgment is recognized to be positive, the process proceeds to step S318.

At step S318, the transmission unit 402 of the second relay apparatus transmits a robot alight instruction to the reception unit 22 of the robot server 2.

### 3-3. Operation and Effects of Elevator System of Third Embodiment

Next, operation and effects of the elevator system according to the third embodiment will be described.

When the second relay apparatus 40 receives a robot operation resumption signal during the predetermined waiting time after receiving a robot operation stop signal, the evacuation floor selection processing by the evacuation floor selection unit 408 is performed. Thereby, even if robot operation stops once due to a failure or the like, the possibility of proceeding to resumption of the robot operation can be left. Thereby, it is possible to reduce the time and effort to manually cause the robot 1 to alight from the inside of a car.

Further, the second relay apparatus 40 can judge security restricted floors separately from back floors, based on in-car destination floor button registration possibility/impossibility information obtained during the latest non-directional stop of each car 11. Thereby, it is possible to reduce the possibility of misjudging back floors as security restricted floors and reduce misjudgment in the evacuation floor selection processing.

Further, since the evacuation floor selection unit 408 prioritizes a floor at the shortest distance from a current car position in the evacuation floor selection processing, it is possible to evacuate the robot 1 as soon as possible.

### Fourth Embodiment

In a fourth embodiment, points different from the examples disclosed in the first to third embodiments will be especially described in detail. As for characteristics that are not described in the fourth embodiment, any of the characteristics of the examples disclosed in the first to third embodiments may be adopted.

### 4-1. Functions of Elevator System of Fourth Embodiment

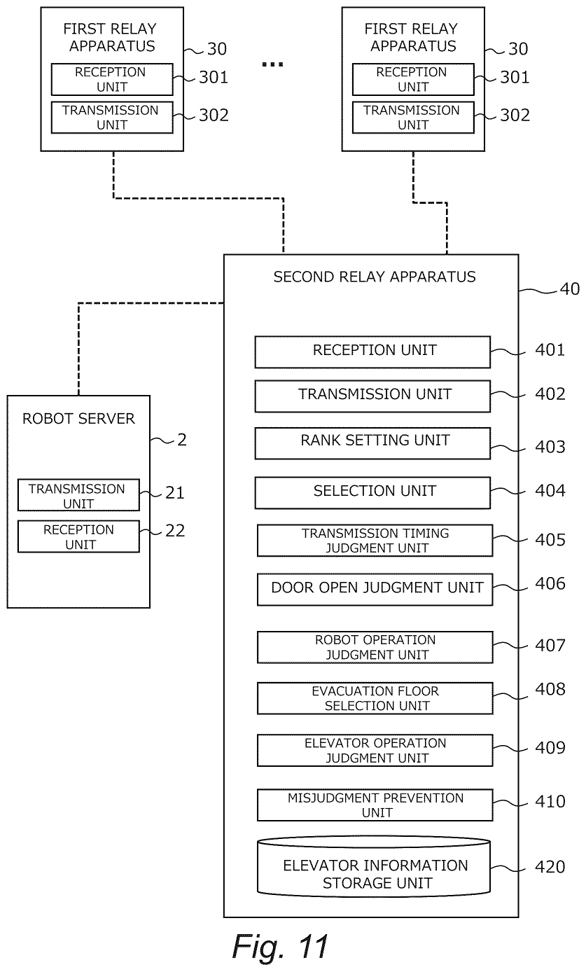

FIG. 11 is a block diagram showing functions of the elevator system according to the fourth embodiment. The second relay apparatus 40 of the fourth embodiment further includes an elevator operation judgment unit 409 and a misjudgment prevention unit 410 in addition to the functions of the second relay apparatus 40 of the third embodiment.

The elevator operation judgment unit 409 has a function of judging whether the operation state of the car 11 of each of the units is an operating or stopped state, based on elevator information stored in the elevator information storage unit 420.

The misjudgment prevention unit 410 has a function of preventing the elevator operation judgment unit 409 from making a misjudgment that an elevator is being stopped when the car position is on a terminal floor, based on elevator information stored in the elevator information storage unit 420.

### 4-2. Operation Example of Elevator System of Fourth Embodiment

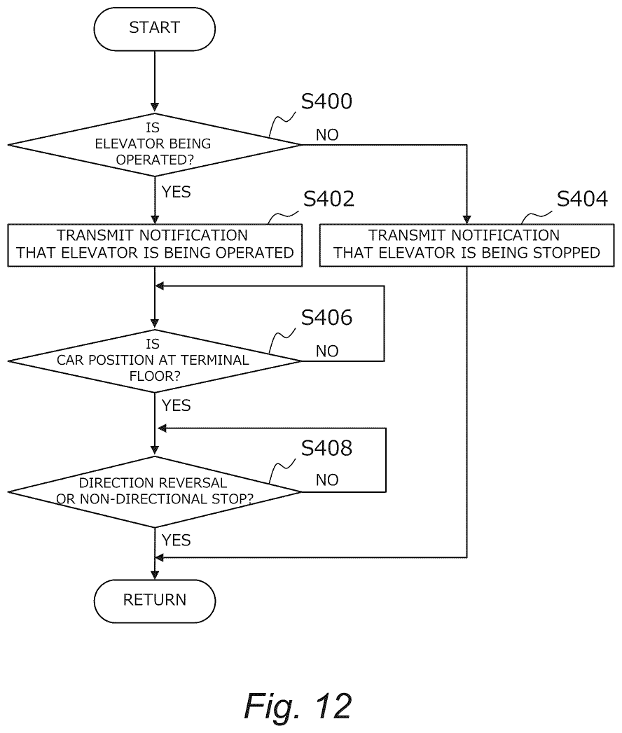

FIG. 12 is a flowchart showing an operation example of the elevator system according to the fourth embodiment. The routine shown in FIG. 12 is continuously executed for each of the units in the elevator system.

At step S400 of the routine shown in FIG. 12, the elevator operation judgment unit 409 judges whether the operation state of the car 11 of each of the units is an operating or stopped state, based on elevator information stored in the elevator information storage unit 420. Here, the elevator operation judgment unit 409 judges that the elevator is being stopped when none of the in-car destination floor buttons for all the floors is registered, and none of the in-car destination floor buttons for all the floors is registerable. In other cases, the elevator is judged be being operated. As a result, if the elevator is being operated, the process proceeds to step S402; and, if the elevator is being stopped, the process proceeds to step S404.

At step S402, the transmission unit 402 of the second relay apparatus 40 transmits a notification that the elevator is being operated, to the reception unit 22 of the robot server 2. When the processing of step S402 is completed, the process proceeds to step S406.

At step S404, the transmission unit 402 of the second relay apparatus 40 transmits a notification that the elevator is being stopped, to the reception unit 22 of the robot server 2. When the processing of step S404 is completed, the present routine is ended. At step S406, the misjudgment prevention unit 410 judges whether a condition that the current car position is located on a terminal floor is met or not, based on the elevator information stored in the elevator information storage unit 420. As a result, if the condition is not recognized to be met, the process returns to S406 again. On the other hand, if the condition is recognized to be met, the process proceeds to step S408.

At step S408, the misjudgment prevention unit 410 judges whether the car 11 has reversed direction or non-directionally stopped, based on elevator information stored in the elevator information storage unit 420. As a result, if the judgment is not recognized to be positive, the process returns to S408 again. On the other hand, if the judgment is recognized to be positive, the present routine is ended.

### 4-3. Operation and Effects of Elevator System of Fourth Embodiment

Next, operation and effects of the elevator system according to the fourth embodiment will be described.

The second relay apparatus 40 can judge whether an elevator car is being operated or stopped, by the elevator operation judgment unit 409 and notify the robot server 2 of a result of the judgment in real time. Further, the result of the judgment by the elevator operation judgment unit 409 can be used as an elevator state used for the setting operation by the rank setting unit 403. In this case, for example, a candidate car that is being stopped may be excluded from assignment candidates.

When the car position is on a terminal floor, the misjudgment prevention unit 410 can prevent the elevator operation judgment unit 409 from operating until it is judged that the car has reversed the direction or non-directionally stopped. Thereby, it is possible to, when all the floors become back floors when the car position is on a terminal floor, prevent the elevator operation judgment unit 409 from making a misjudgment.

### Fifth Embodiment

In a fifth embodiment, points different from the examples disclosed in the first to fourth embodiments will be especially described in detail. As for characteristics that are not described in the fifth embodiment, any of the characteristics of the examples disclosed in the first to fourth embodiments may be adopted.

### 5-1. Configuration of Building System of Fifth Embodiment

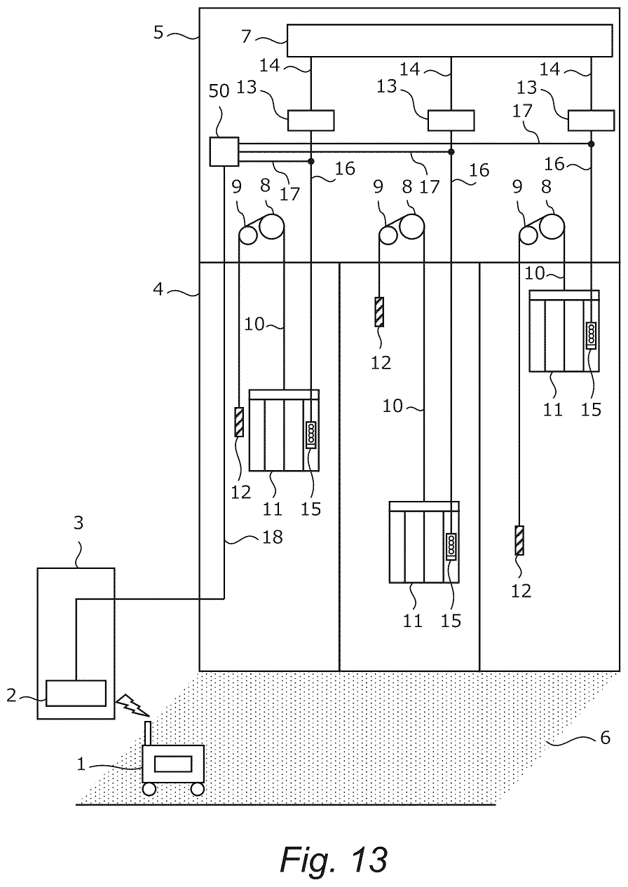

FIG. 13 is a configuration diagram of a building system according to the fifth embodiment. An elevator system, which is an internal system of the building system in the present embodiment is such that the plurality of first relay apparatuses 30 and the second relay apparatus 40 in the elevator systems in the first to fourth embodiments are integrated as a relay apparatus 50. Since other components are similar to those of the building system of each embodiment, detailed description thereof will be omitted.

The relay apparatus 50 electrically connects to the car control devices 13 of the cars 11 via the relay cables 17, respectively. The relay cables 17 connecting to the relay apparatus 50 are electrically connected to the car transmission cables 16, respectively, the car transmission cables 16 connecting the car control devices 13 of the cars 11 and the cars 11, respectively. The relay apparatus 50 is provided in the machine room 5.

The relay apparatus 50 electrically connects to the robot server 2 via the cable 18. The relay apparatus 50 may wirelessly connect to the robot server 2. The relay apparatus 50 may be provided in the control room 3.

### 5-2. Functions of Elevator System of Fifth Embodiment

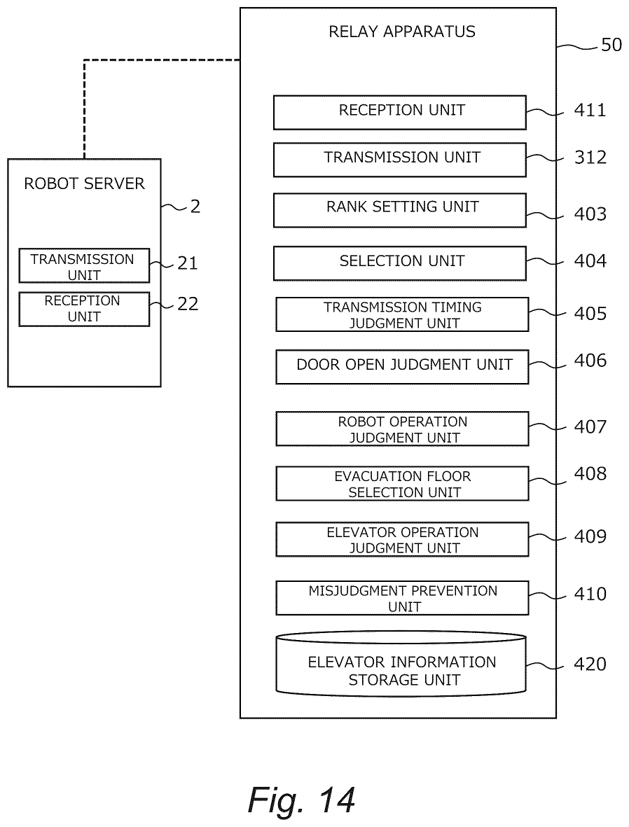

FIG. 14 is a block diagram showing functions of the elevator system according to the fifth embodiment. In comparison with the functions of the second relay apparatus 40 shown in FIG. 11, the relay apparatus 50 of the fifth embodiment includes a reception unit 411 instead of the reception unit 401 and includes a transmission unit 312 instead of the transmission unit 402. The other functions included in the relay apparatus 50 of FIG. 14 are configured similarly to those of the second relay apparatus of FIG. 11.

The transmission unit 21 of the robot server 2 has a function of transmitting a use request including information about a call of the robot 1, to the reception unit 411 of the relay apparatus 50 and a function of transmitting a robot operation stop signal and a robot operation resumption signal to the reception unit 411 of the relay apparatus 50. The reception unit 22 of the robot server 2 has a function of receiving assigned car information identifying a car 11 to which a call of the robot 1 is assigned, from the transmission unit 312 of the relay apparatus 50.

The reception unit 411 of the relay apparatus 50 has a function of receiving a use request and a robot operation stop signal from the transmission unit 21 of the robot server 2 and a function of receiving pieces of elevator information from the car control devices 13. The reception unit 411 of the relay apparatus 50 has a function of, each time elevator information about a corresponding unit changes, receiving the elevator information from the car control device 13 of the unit.

The transmission unit 312 of the relay apparatus 50 has a function of transmitting a request to register a boarding-floor car call to an assigned car selected by the selection unit 404 and a request to register a destination-floor car call to the assigned car, to the car control device 13 of the corresponding car. Further, the transmission unit 312 of the relay apparatus 50 has a function of transmitting information identifying the assigned car selected by the selection unit 404, to the reception unit 22 of the robot server 2.

As for the functions of the transmission unit 21 and the reception unit 22 included in the robot server 2 of the first to fifth embodiments, the robot 1 may be equipped with the functions. The second relay apparatus 40 or the relay apparatus 50 may directly communicate with the robot 1 not via the robot server 2.

### REFERENCE SIGNS LIST

1 Robot
2 Robot server
3 Control room
5 Machine room
6 Hall
7 Group control apparatus
8 Traction machine
9 Deflector wheel
10 Main rope
12 Counterweight
13 Car control device
14 Transmission cable
15 Car operating panel
16 Car transmission cable
17 Relay cable
18 Cable
19 Hoistway transmission cable
21 Transmission unit
22 Reception unit
23 Entrapment judgment unit
30 First relay apparatus
40 Second relay apparatus
50 Relay apparatus
100 Processing circuitry
100a Processor
100b Memory
301 Reception unit
302 Transmission unit
312 Transmission unit
401 Reception unit
402 Transmission unit
403 Rank setting unit
404 Selection unit
405 Transmission timing judgment unit
406 Door open judgment unit
407 Robot operation judgment unit
408 Evacuation floor selection unit
409 Elevator operation judgment unit
410 Misjudgment prevention unit
411 Reception unit
420 Elevator information storage unit

What is claimed is:

1. An elevator system comprising:
a plurality of first relay apparatuses corresponding to a plurality of cars of an elevator provided in a facility, respectively, and being connected so as to be capable of receiving pieces of elevator information obtained from car operating panels of the corresponding cars, respectively, and transmitting instructions executable from the car operating panels to car control devices, respectively; and
a second relay apparatus connected so as to be capable of communicating with each of the plurality of first relay apparatuses; wherein
the second relay apparatus comprises processing circuitry, the processing circuitry
receiving a use request, the use request including information about a call from a boarding floor to a destination floor of a robot moving in the facility, and
transmitting, to a first relay apparatus corresponding to an assigned car to which the call of the robot included in the use request is assigned, among the plurality of first relay apparatuses, a request to register the call of the robot; and
each of the plurality of first relay apparatuses is configured to receive
the request to register the call of the robot transmitted by the second transmission unit, and transmit
the received request to register the call of the robot, to a corresponding car control device among the car control devices.

2. The elevator system according to claim 1, wherein
each of the pieces of elevator information includes at least any one piece of information among a piece of car position information, a piece of car travel direction information, a piece of door open button lamp lighting information, a piece of in-car destination floor button lighting information, and a piece of in-car destination floor button registration possibility/impossibility information about a corresponding car;
the plurality of first relay apparatuses are configured to transmit the pieces of elevator information, respectively, to the second relay apparatus; and
the processing circuitry of the second relay apparatus receives the pieces of elevator information from the plurality of first relay apparatuses, respectively, and determines the assigned car based on the received pieces of elevator information.

3. The elevator system according to claim 2, wherein
the processing circuitry of the second relay apparatus is configured to set ranks as candidate cars to which the call of the robot included in the use request is to be assigned, for at least any one or more of the plurality of cars, based on the received pieces of elevator information; and select the assigned car from among the candidate cars for which the ranks are set.

4. The elevator system according to claim 3, wherein
the pieces of elevator information include the pieces of in-car destination floor button registration possibility/impossibility information, respectively; and
the processing circuitry is configured to exclude such a car that floors set to be unregisterable in the piece of in-car destination floor button registration possibility/impossibility information obtained during latest non-directional stop of the car, among the received pieces of in-car destination floor button registration possibility/impossibility information, include the boarding floor or the destination floor, from the candidate cars.

5. The elevator system according to claim 3, wherein
the pieces of elevator information include the pieces of car position information and the pieces of car travel direction information, respectively; and
the processing circuitry is configured to judge whether a condition is met or not that the boarding floor and the destination floor are located in that order ahead in a car travel direction from a current car position, based on each of the received pieces of car position information and pieces of car travel direction information, and set the ranks as the candidate cars based on whether the condition is met or not.

6. The elevator system according to claim 3, wherein
the pieces of elevator information include the pieces of car position information and the pieces of car travel direction information, respectively; and
the processing circuitry is configured to set the ranks as the candidate cars based on distances from current car positions to the boarding floor calculated based on the pieces of car position information and the pieces of car travel direction information that have been received.

7. The elevator system according to claim 3, wherein
the processing circuitry of the second relay apparatus is configured to judge whether a condition is met or not that the boarding floor and the destination floor are located in that order ahead in a travel direction of an assigned car from a current position of the assigned car, based on a corresponding piece of car position information among the pieces of car position information and a corresponding piece of car travel direction information among the pieces of car travel direction information, and, if the condition is met, transmit a request to register a car call to the assigned car.

8. The elevator system according to claim 3, wherein
the processing circuitry of the second relay apparatus is configured to judge whether a door open condition is met or not that a door of the assigned car is open at the boarding floor; and
the processing circuitry is configured to, when the door open condition is met, transmit a request to register a car call to the destination floor, to a first relay apparatus corresponding to the assigned car.

9. The elevator system according to claim 3, wherein
the processing circuitry of the second relay apparatus is configured to judge, when a judgment of robot operation stop due to a factor on an elevator side has been made, whether the robot operation has become resumable during waiting time after the stop judgment.

10. The elevator system according to claim 9, wherein
the processing circuitry of the second relay apparatus is configured to select an evacuation floor where the robot is to be evacuated when it is judged that the robot operation has become resumable.

11. The elevator system according to claim 1, wherein
the processing circuitry of the second relay apparatus is configured to, when the elevator is located at a terminal floor, suspend judgment about whether the elevator is being operated or not until the elevator reverses direction or non-directionally stops.

12. A second relay apparatus communicably connected to each of a plurality of first relay apparatuses, the plurality of first relay apparatuses corresponding to a plurality of cars of an elevator provided in a facility, respectively, and being connected so as to be capable of receiving pieces of elevator information obtained from car operating panels of the corresponding cars, respectively, and transmitting instructions executable from the car operation panels to car control devices, respectively, the second relay apparatus comprising processing circuitry, and the processing circuitry receiving a use request, the use request including information about a call from a boarding floor to a destination floor of a robot moving in the facility and transmitting, to a first relay apparatus corresponding to an assigned car to which the call of the robot included in the use request is assigned, among the plurality of first relay apparatuses, a request to register the call of the robot to be transmitted to a corresponding car control device among the car control devices.

13. A relay apparatus connected so as to be capable of receiving pieces of elevator information obtained from car operating panels of a plurality of cars of an elevator provided in a facility, respectively, and transmitting instructions executable from the car operating panels to car control devices corresponding to the plurality of cars, respectively, the relay apparatus comprising processing circuitry, the processing circuitry receiving a use request, the use request including information about a call from a boarding floor to a destination floor of a robot moving in the facility and transmitting, to a car control device corresponding to an assigned car to which the call of the robot included in the use request is assigned, among the car control devices corresponding to the plurality of cars, respectively, a request to register the call of the robot, wherein
the relay apparatus is configured separately from a group control apparatus, the group control apparatus being connected to the car control devices and assigning a hall call of a user to any of the plurality of cars.

14. An elevator system comprising the relay apparatus according to claim 13.

15. A relay method for receiving pieces of elevator information obtained from car operating panels of a plurality of cars of an elevator provided in a facility, respectively, and transmitting instructions executable from the car operating panels to car control devices corresponding to the plurality of cars, respectively, wherein
the relay apparatus causes a relay apparatus configured separately from a group control apparatus, the group control apparatus being connected to the car control devices and assigning a hall call of a user to any of the plurality of cars, to execute the steps of:
receiving a use request, the use request including information about a call from a boarding floor to a destination floor of a robot moving in the facility;
determining an assigned car to which the call of the robot included in the use request is to be assigned, based on the pieces of elevator information; and
transmitting a request to register the call of the robot to a car control device corresponding to the assigned car.

16. A computer-readable recording medium with a relay program recorded therein, the relay program causing a computer of a relay apparatus to execute receiving pieces of elevator information obtained from car operating panels of a plurality of cars of an elevator provided in a facility, respectively, and transmitting instructions executable from the car operating panels to car control devices corresponding to the plurality of cars, respectively, the relay apparatus being configured separately from a group control apparatus, the group control apparatus being connected to the car control devices and assigning a hall call of a user to any of the plurality of cars, wherein
the relay program is configured to cause the computer to execute:
receiving a use request, the use request including information about a call from a boarding floor to a destination floor of a robot moving in the facility;
determining an assigned car to which the call of the robot included in the use request is to be assigned, based on the pieces of elevator information; and
transmitting a request to register the call of the robot to a car control device corresponding to the assigned car.
